(19) United States
(12) Patent Application Publication
(10) Pub. No.: US 2010/0028528 A1
(43) Pub. Date: Feb. 4, 2010

(54) USE OF CYCLOHEXANE POLYCARBONIC ACID ESTERS FOR THE PRODUCTION OF COATING MATERIALS FOR THE COIL COATING METHOD AND THE PRODUCTION OF COATED COILS

(75) Inventors: Deborah Lois Coombs, Wrexham (GB); Paul Michael Davies, South Wirral (GB); Ulrik Stengel, Shanghai (CN); Christopher David Morgan, Cheshiere (GB)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/519,968

(22) PCT Filed: Nov. 26, 2007
(86) PCT No.: PCT/EP2007/062819

§ 371 Date: Jun. 18, 2009

(30) Foreign Application Priority Data
Dec. 19, 2006 (EP) 06126530.2

(51) Int. Cl. B05D 5/12

(52) U.S. Cl. 427/116

(57) ABSTRACT

The use of cyclohexane polycarboxylic acid esters for the preparation of coating compositions for the coil coating process containing at least one paste PVC and at least one extender PVC and of coated coils, the coil coating process, which is carried out by using coating compositions containing cyclohexane polycarboxylic acid esters, one-sided or two-sided coated coils with at least one coating composition containing at least one cyclohexane polycarboxylic acid ester as well as three-dimensional formed parts preparable by the shaping of the said coated coils.

### FIELD OF THE INVENTION

The present invention is directed to the new use of cyclohexane polycarboxylic acid esters for the preparation of coating compositions for the coil coating process and for coated coils. Further, the present invention is directed to a new coil coating process, which is carried out by using coating compositions containing cyclohexane polycarboxylic acid esters. Moreover, the present invention relates to new coated coils, which have been prepared by the new coil coating process. Last but not least, the present invention relates to new formed parts which have been prepared from the new coated coils.

### PRIOR ART

The term coil coating is to be understood as a special process of roller coating (cf. Römpp Lexikon Lacke und Druckfarben, Georg Thieme Verlag, Stuttgart, New York, 1998, Seite 617, “Walzlackierung”) and, sporadically, of spray coating and curtain coating of metal coils with liquid coatings. It concerns a continuously working process, i.e., all process steps such as cleaning, pretreating, and cross-linking are conducted in one operation in one facility. Schematically, the coil coating encompasses the following steps: After the cleaning and the degreasing of the coil a multiple step chemical pretreatment is carried out followed by passivating, rinsing and drying. After the cooling, the one-sided or two-sided application of the liquid coating composition with two or three rollers is carried out, mostly by using the reverse roller coating process. Optionally after a short flash-off time, the thermal aftertreatment of the applied layer, in particular the hardening or the gelling, is carried out at higher temperatures, as for example, at 140 to 260° C., during a short time period, as for example, during 10 to 60 s. During the preparation of a multilayer coating the application and, optionally so, the thermal after treatment or the thermal hardening or the gelling are repeated several times. The speeds of the coil coating lines can come up to 250 m/min (cf. Römpp Lexikon Lacke und Druckfarben, Georg Thieme Verlag, Stuttgart, New York, 1998, Seite 617, “Walzlackierung”).

The use of benzene polycarboxylic acid esters, in particular phthalic acid esters, for the preparation of coating compositions on the basis of PVC, which coating compositions are used in the coil coating process, is well-known. The benzene polycarboxylic acid esters are used as plasticizers for the PVC. The line-speed of the known coil coating processes ought to come up to at least 100 m/min.

Hereinafter the terms polyvinyl chloride or PVC are to be understood as homopolymers and copolymers of vinyl chloride (cf., for example, the international patent application WO 03/29339 A1, page 16, line 6 to page 17, line 27; the German utility model DE 200 21 356 U1, page 44, lines 4 to 15; or Römpp Online 2006, “polyvinyl chlorides”). As a rule, the PVC fraction of the known coating compositions consists of a paste PVC and an extender PVC. The difference between a paste PVC and an extender PVC can be explained best by the respective particle size distribution. Whereas the mean particle diameter of the paste PVC is, as a rule, in the range of 1 to 15 μm, the extender PVC typically exhibits values of from 25 to 35 μm. The particle structure of the extender PVC should be as spherical as possible and—in contrast to the typical suspension polymers for the thermoplastic processing—should exhibit a very low porosity (cf. the corporate paper of the Vinnolit GmbH & Co. KG, Carl-Zeiss-Ring 25, D-85737 Ismaning, >>Vinnolit Leadership in PVC<<, November 2006).

Cyclohexane polycarboxylic acid esters and methods for their preparation are known, for example, from the international patent applications WO 99/32427, WO 02/066412 A1, WO 03/029339 A1 or WO 2005/123821 A2, the German utility model DE 200 21 356 U1 or the German patent application DE 101 16 812 A1.

The known cyclohexane polycarboxylic acid esters can be used in many ways.

Thus, the use as plasticizers for PVC is known from the international patent application WO 99/32427. According to page 23, lines 5 to 15 of the WO 99/32427, as compared with the phthalates hitherto mainly used as plasticizers, the analogous cyclohexane polycarboxylic acid esters exhibit a lower density and viscosity and, inter alia, lead to an improvement of the cold flexibility of the plastic as compared with the use of the analogous phthalates as the plasticizers, the properties like the shore A hardness and the mechanical properties of the resulting plastics being identical to those resulting from the use of the phthalates. Moreover, the cyclohexane polycarboxylic acid esters have an improved processing behavior in dry blends and, as a result, a higher speed of production as well as advantages in the plastisol processing due to a significantly lower viscosity as compared with the analogous phthalates.

The same use is known from the German utility model DE 200 21 356 U1. According to page 48, line 24 to page 49, line 9 of the DE 200 21 356 U1, the plasticizers excel in that they exhibit a low density and viscosity, which results in more favorable volume costs of the concerned soft PVC articles. Moreover, the lower viscosity improves the processability in the plastisol process. Further, the plasticizers exhibit a lower volatility. In particular, the concerned soft PVC articles excel in very good cold elastic properties, i.e. in a low cold breaking temperature (measured according to DIN 53372) and a low torsion stiffness (measured according to DIN 53447). Additionally, an improved thermal stability results for the soft PVC articles, which is characterized by a higher oven stability (measured according to DIN 53381, part 2, method E) and the higher HCl residual stability (measured according to the VDE norm 0472, §614). The concerned soft PVC articles can be used, for example, in housings for electronic devices, pipes, apparatuses, cables, wire coatings, window profiles, in interior construction, in the vehicle and furniture construction, in floor coverings, medical articles, food packaging, sealing gaskets, foils, laminated foils, audio discs, artificial leather, toys, packaging containers, adhesive films, coatings or in fibers for textiles. This also follows from the international patent application WO 02/066412, in particular page 25, line 7 to page 26, line 13; or the German patent application DE 101 16 812 A1, in particular page 16, paragraphs [0058] to [0064].

According to the international patent application WO 03/029339 A1, the PVC materials plasticized with the cyclohexane polycarboxylic acid esters can be used for the preparation of pipes, wire and cable coatings, floor tiles, window shades, films, blood bags and medical tubing, sheeting, upholstery, garden hoses, pool liners, water beds, coated cloth, toys or shoe soles. Because the cyclohexane polycarboxylic acid esters lead to an improved UV-stability, the concerned plasticized PVC materials can be used, in particular, for outdoor applications, as for example, roofing, tarpaulins, films, such as adhesive tapes and agricultural films, shoes and automobile interiors and underbody coatings for car bodies. The plasticized PVC materials can be processed by extrusion, molding or calendering. In doing so, the known cyclohexane polycarboxylic acid esters lead to a decrease of the viscosity (cf., in particular, page 2, line 32 to page 8, line 33 and the claims 15 to 18 of the WO 03/029339 A1).

Moreover, it is known from the international patent application WO 2005/123821 A2 to use 1,2-cyclohexane dicarboxylic acid diesters in additives or as additives, such as
surface active compositions, such as flowing and film building aids, defoamers, foam inhibitors, wetting agents, coalescence agents and emulsifiers;
lubricants;
calendering aids;
rheology agents;
quenchers for chemical reactions;
phlegmatizing agents;
pharmaceutical products;
plasticizers in adhesives;
impact strength modifiers and
auxiliary agents
   (cf. in detail page 15, line 13 to page 24, line 9 of the WO 2005/123821 A2).

The use of the cyclohexane polycarboxylic acid esters for the preparation of coating compositions for the coil coating process and for coated coils is known as such.

Thus, the U.S. Pat. No. 4,208,488 discloses coating compositions for the coil coating process containing homo- and/or copolymers derived from vinyl monomers having up to 2 fluorine atoms (i.e. fluoroethylene and 1,1-difluoroethylene).

Coating compositions for the coil coating process containing PVC and vinyl chloride copolymers in general are known from the international patent application WO 2004/022606 A1. Mixtures of paste PVC and extender PVC are not mentioned.

The international patent application WO 2004/081127 A1 only discloses printing inks for metal foils containing PVC copolymers in general. Contrary to this, mixtures of paste PVC and extender PVC are not mentioned.

### OBJECTS TO BE SOLVED

It was the object of the invention here in question to find a new use for the cyclohexane polycarboxylic acid esters.

In particular, it was the object of the invention here in question to significantly increase the speed of the coils in the coil coating processes, wherein coating compositions on the basis of plasticized PVC are continuously applied onto coils, in particular metal coils, whereafter the applied layers are thermally hardened or gelled, in order to further improve the operating efficiency of the coil coating processes.

Last but not least, it was the object of the invention here in question to provide coated coils prepared with the coil coating process, the coatings of which are at least equal to or even surpass the coatings prepared by using phthalic diesters in terms of their mechanical, chemical and physical properties, in particular in their cold flex properties, their thermal stability and their adhesion to the coils or, as the case may be, the primer coatings applied thereon. At the same time the coated coils or their coatings ought to exhibit a better weathering stability, in particular, a better UV stability, than the coated coils or their coatings prepared by using phthalic acid diesters.

Moreover, the coated coils ought to be easily processible, in particular, they should be easily shapable also at low temperatures without the occurrence of cracks or delamination, so that the production of particularly strongly shaped and particularly complexly structured formed parts is made possible.

The concerned three-dimensional formed parts should be excellently suited for numerous interior and exterior applications, as for example, in the production of automobiles for the preparation of car bodies and parts of car bodies, superstructures for utility vehicles and paneling for caravans; in the area of household appliances, as for example, for the preparation of washing machines, automatic dishwashers, dryers, refrigerators, freezers or stoves; in the area of lighting for the production of lamps for the interior and exterior application; or in the area of the interior and exterior construction, as for example, for the production of ceiling and wall elements, doors, gateways, isolation for pipes, shutters or window profiles.

### SOLUTION ACCORDING TO THE INVENTION

Therefore, the new use of cyclohexane polycarboxylic acid esters for the preparation of coating compositions for the coil coating process containing at least one paste PVC and at least one extender PVC, and of coated coils was found, which use will be referred to hereinafter as the “use according to the invention”.

Further, the new coil coating process was found, wherein the coating compositions containing the cyclohexane polycarboxylic acid esters, at least one paste PVC and at least one extender PVC are used and which process will be referred to hereinafter as the “process according to the invention”.

Moreover, the new coated coils preparable by the process according to the invention were found, which coated coils will be hereinafter referred to as the “coils according to the invention”.

Last but not least, the new formed parts were found, which formed parts are prepared from the coils according to the invention and which will be referred to hereinafter as the “formed parts according to the invention”.

### ADVANTAGES OF THE INVENTION

In view of the prior art it was surprising and could not be expected by the skilled artisans that the object underlying the present invention could be solved by way of the use according to the invention, the process according to the invention, the coils according to the invention and the formed parts according to the invention.

It was particularly surprising that because of the use according to the invention the speed of the coils could be significantly increased in the case of the process according to the invention as compared with the speed of the coils in the case of the coil coating processes according to the prior art, so that the production efficiency of the process according to the invention surpassed the one of the prior art coil coating processes.

Not the least, did the coils according to the invention and the coatings located thereon at least compare with the coils and the coatings prepared by the use of phthalic acid diesters in terms of their mechanical, chemical and physical properties, in particular their cold flex properties, their thermal stability and their adhesion to the coils or to the primer coatings located thereon, if they did not even surpass them in this regard. At the same time, the coils of the invention or their coatings exhibited a better weathering stability, in particular, UV stability than the coils and their coatings prepared by the use of phthalic acid diesters.

Moreover, the coils according to the invention could be easily processed, in particular, shaped easily also at low temperatures without the occurrence of cracks or delamination so that the production of particularly strongly shaped and particularly complexly structured formed parts was made possible.

The concerned three-dimensional formed parts were excellently suited for numerous interior and exterior applications, as for example, in the production of automobiles for the preparation of car bodies and parts of car bodies, superstructures for utility vehicles and paneling for caravans; in the area of household appliances, as for example, for the preparation of washing machines, automatic dishwashers, dryers, refrigerators, freezers or stoves; in the area of lighting for the production of lamps for the interior and exterior application; or in the area of the interior and exterior construction, as for example, for the production of ceiling and wall elements, doors, gateways, isolation for pipes, shutters or window profiles.

### DETAILED DESCRIPTION OF THE INVENTION

The invention here in question concerns the use of cyclohexane polycarboxylic acid esters for the preparation of coating compositions containing at least one paste PVC and at least one extender PVC for the process of the invention and of the coils according to the invention.

The coating compositions for the process of the invention are capable of flowing. This means that they can be free-flowing fine powders or liquids or melts at their processing temperatures, in particular at 0 to 150° C. The liquids or melts can be homogeneous or heterogeneous materials such as dispersions. Preferably, the coating compositions are liquid dispersions at room temperature.

The coating compositions to be used according to the invention can be used for the preparation of primer coatings, backside coatings or top coats. Preferably, they are used for the preparation of top coats.

In the process according to the invention the coating compositions are continuously applied one-sided or two-sided onto coils. The methods of application conform with the state of aggregation of the coating compositions. Thus, pulverulent coating compositions are usually applied by powder spraying processes which are optionally supported electrostatically. Liquid or molten coating compositions are usually applied by curtain coating or roller coating, in particular roller coating.

The coils are strips consisting of metals. In particular, coils consisting of steel, galvanized steel and aluminum are used. The maximum strip width of the metal coils is generally about 2000 mm. The thickness of the metal coils is generally of from 0.2 to 2 mm.

Before the application of the coating compositions the coils are cleaned and degreased. Thereafter, a multistep chemical pretreatment followed by rinsing, passivation and drying is carried out. After the cooling-off, the one-sided or two-sided application of the preferably liquid coating composition is carried out. In the case of the preferred use of the coating composition for the preparation of a top coat, the coils are afore provided with a primer coating and, optionally, with a backside coating.

After their application the applied coatings are subjected to a thermal aftertreatment, optionally after a very short flash-off time, preferably 3 to 10 s. During this step maximum metal temperatures (peak metal temperatures; PMT) of from 140 to 260° C. are reached. The duration of the thermal aftertreatment is generally from 20 to 120 s. By way of the thermal aftertreatment a hardening or gelling of the coating is achieved. The speed of the coils reaches up to 200 m/min.

The design of the coating of the resulting coils according to the invention can vary broadly. Preferably, the coating consists of a backside coating and a primer coating, which is located on the side opposite to the backside, and a top coat located on the primer coating. Preferably, the primer coatings have a layer thickness of 5 to 8 μm. Preferably, the top coats have a layer thickness of 50 to 350 μm, in particular 100 to 300 μm. Preferably, the backside coatings have a layer thickness of from 8 to 10 μm.

The top coats of the coils according to the invention can be provided with embossments in the surface. Laminates can also be applied. Not the least, peelable protective foils can be provided which protect the coils according to the invention during their storage, transportation and mounting. The coils according to the invention are wound up into rolls and stored and transported in this form.

For the preparation of the formed parts of the invention the rolls are again unwound, and the coils of the invention are cut into plates of the required dimensions. Thereafter, the plates are shaped in a suitable way, in particular, by punching, reshaping, profiling, edge bending and deep drawing, to yield the desired formed parts.

For further details of the coil coating process reference is made to A. Goldschmidt und H.-J. Streitberger, BASF-Handbuch Lackiertechnik, Vincentz Verlag, Hannover, 2002, >>7.4 Coil Coating<<, Seiten 751 bis 756, and Römpp Online 2006, >>Bandbeschichtung<<.

The cyclohexane carboxylic acid esters to be used according to the invention can comprise more than 6 carboxylic acid esters groups. Preferably, they contain not more than 6 carboxylic acid ester groups. More preferably, the carboxylic acid esters groups are connected via their carbonyl groups with different carbon atoms of the cyclohexane ring. This means that a given carbon atom of the cyclohexane ring preferably carries only one carboxylic acid ester group. Therefore, the cyclohexane polycarboxylic acid esters preferably contain 2 to 6, more preferably 2 to 5, most preferably 2 to 4, particularly preferably 2 to 3, and most particularly preferably 2 carboxylic acid esters groups.

The carboxylic acid ester groups in a given cyclohexane polycarboxylic acid ester can be the same or different from each other.

The cyclohexane polycarboxylic acid esters can be stereoisomers being different from each other, such as cis- or trans-isomers, and/or constitutional isomers, such as 1,2,4,5 I-, 1,2,3,4- or 1,2,3,5-cyclohexane tetracarboxylic acid tetraesters, 1,3,5-, 1,2,3- or 1,2,4-cyclohexane tricarboxylic acid triesters or 1,2-, 1,3- or 1,4-cyclohexane dicarboxylic acid diesters. Preferably, the cyclohexane dicarboxylic acid diesters, in particular, the 1,2-cyclohexane dicarboxylic acid diesters are used.

The cyclohexane polycarboxylic acid esters can carry further substituents. These optional substituents are inert, which means that they do not enter into or initiate chemical reactions under the conditions of the use of the cyclohexane polycarboxylic acid esters and the concerned coating compositions and coated coils. Examples of suitable inert substituents are halogen atoms, nitrile groups, optionally halogenated alkyl and cycloalkyl groups as well as alkoxy and cycloalkoxy groups. In case that alkyl and cycloalkyl groups are used as the substituents, the said groups can be connected with two or more carbon atoms of the cyclohexane ring in the form of a bridge so that a polycyclic basic structure results, which basic structure can be derived from, for example, norbonane or adamantane. Preferably, the cyclohexane polycarboxylic acid esters do not contain further substituents.

Preferably, the ester groups of the cyclohexane polycarboxylic acid esters contain moieties selected from the group consisting of branched and non-branched, substituted and non-substituted alkyl moieties, cycloalkyl moieties and alkoxyalkyl moieties. The aforementioned substituents can come into question as the substituents. Preferably, the moieties contain 1 to 30, most preferably 2 to 20 and particularly preferably 3 to 18 carbon atoms. Most preferably, the moieties are branched. Particularly preferably, the moieties are non-substituted. Most particularly preferably, the moieties are alkyl moieties preferably with 2 to 20, more preferably with 3 to 18, most preferably with 6 to 16, particularly preferably with 8 to 12 and most particularly preferably with 9 carbon atoms.

Examples of suitable cyclohexane polycarboxylic acid esters as well as suitable processes for their preparation are known from the international patent applications
WO 99/32427, page 16, lined 31 to page 21, line 6, page 21, line 11 to page 22, line 15 and page 22, lines 25 to 31;
WO 02/066412 A1, page 18, line 25 to page 20, line 5 in conjunction with page 4, line 6 to page 18, line 23;
WO 03/029339 A1, page 17, line 29 to page 22, line 10; and
WO 2005/123821 A2, page 3, line 6 to page 6, line 11 and page 6, line 13 to page 14, lined 37;
   the German patent application
DE 101 16 812 A1, page 2, paragraph [0011] to page 14, paragraph (0019]; as well as from
   the German utility model
DE 200 21 356 U1, page 3, line 14 to page 43, line 19.

According to the invention, it is of particular advantage when the alkyl moieties of the carboxylic acid esters groups are isononyl moieties. In particular, the isononyl moieties are derived from isononanols having an iso-index calculated from the degree of branching of the C9-alcohols contained in the isononanol and their fractions as measured by gaschromatography, preferably of from 0.1 to 4, more preferably 0.5 to 3, most preferably 0.8 to 2 and particularly preferably 1 to 1.5. As regards the details reference is made to the international patent application WO 2005/123821 A2, page 10, line 15 to page 14, line 10.

Therefore, the cyclohexane polycarboxylic acid esters which are most advantageously used according to the invention, concern 1,2-cyclohexane dicarboxylic acid diisononyl esters. They are commercial products, which are sold, for example, by BASF AG under the trademark Hexamoll™ DINCH.

In their use according to the invention for the preparation of coating compositions for the coil coating process they are preferably used in an amount of from 5 to 40% by weight, more preferably 5 to 35% by weight, most preferably 5 to 30% by weight and particularly preferably 5 to 25% by weight, each based on the sum total of the coating composition.

The coating composition for the coil coating process comprises at least one paste PVC and at least one extender PVC as defined at the beginning.

The contents of the coating composition of PVC can vary broadly and conforms with the requirements of the individual case. Preferably, the coating composition comprises 10 to 60% by weight, most preferably 15 to 55% by weight and particularly preferably 15 to 50% by weight, each based on the sum total of the coating composition, of paste PVC. Preferably, the coating composition comprises 10 to 55% by weight, most preferably 15 to 50% by weight and particularly preferably 15 to 45% by weight, each based on the sum total of the coating composition, of extender PVC.

Moreover, the coating composition can comprise at least one additive selected from the group consisting of stabilizers, slipping agents, fillers, pigments, flame inhibitors, light stabilizers, blowing agents, polymer processing aids, impact strength modifiers, optical brighteners, antistatic agents, biostabilizers and polymers being different from PVC. In particular, additives are used which are customarily used for PVC-containing materials.

Examples for particularly well-suited PVC additives and the amounts in which they are used are known from the international patent application WO 03/029339 A1, page 22, line 22 to page 24, line 21 or from the German patent application DE 101 16 812 A1, page 15, paragraph [0036] to page 16, paragraph (0056].

The preparation of the coating compositions offers no methodical particularities, but the common and standard processes and apparatuses for the preparation of mixtures of PVC and plasticizers can be used.

Because of the use of the invention the coil speeds of the process of the invention can be significantly increased as compared with the coil speeds of prior art coil coating processes, so that the production efficiency of the process of the invention surpasses the one of the prior art coil coating processes.

The coils according to the invention and the coatings located thereon at least compare with the coils and the coatings prepared by the use of phthalic acid diesters in terms of their mechanical, chemical and physical properties, in particular their cold flex properties, their thermal stability and their adhesion to the coils or to the primer coatings located thereon, and can even surpass them in this regard. At the same time, the coils of the invention or their coatings exhibit a better weathering stability, in particular, UV stability than the coils and their coatings prepared by the use of phthalic acid diesters.

Moreover, the coils according to the invention can be easily processed, in particular, shaped easily also at low temperatures without the occurrence of cracks or delamination so that the production of particularly strongly shaped and particularly complexly structured formed parts is made possible.

The concerned three-dimensional formed parts are excellently suited for numerous interior and exterior applications, as for example, in the production of automobiles for the preparation of car bodies and parts of car bodies, superstructures for utility vehicles and paneling for caravans; in the area of household appliances, as for example, for the preparation of washing machines, automatic dishwashers, dryers, refrigerators, freezers or stoves; in the area of lighting for the production of lamps for the interior and exterior application; or in the area of the interior and exterior construction, as for example, for the production of ceiling and wall elements, doors, gateways, isolation for pipes, shutters or window profiles.

### EXAMPLES AND COMPARATIVE EXAMPLES

### Examples 1 to 4 and Comparative Examples V1 to V4

### The Preparation of Coating Compositions for the Coil Coating Process by Using 1,2-Cyclohexane Dicarboxylic Acid Diisononyl Ester (DINCH) (Examples 1 to 4) and Without the Use of DINCH (Comparative Examples V1 to V4)

The coating compositions of the Examples 1 to 4 and the Comparative Examples V1 to V4 were prepared by mixing the constituents indicated in the Table 1 in the indicated amounts and homogenizing the resulting mixtures

TABLE 1
Composition of the coating compositions of the Examples 1 to 4 and
the Comparative Examples V1 to V4 in percent by weight, based on
the sum total of the coating composition

| | | | | | Comparative Examples | | | |
|---|---|---|---|---|---|---|---|---|
| | Examples (% by weight): | | | | (% by weight) | | | |
| Constituent | 1 | 2 | 3 | 4 | V1 | V2 | V3 | V4 |
| PVC: | | | | | | | | |
| Paste PVC | 32.9 | 30.4 | 33.3 | 29.5 | 32.1 | 39.2 | 40.7 | 30 |
| Extender PVC | 26.9 | 24.9 | 27.2 | 27.2 | 26.2 | 16.8 | 17.4 | 27.7 |
| Plasticizer: | | | | | | | | |
| DIDP^{a)} | — | — | — | — | 20.5 | 15.7 | 16.3 | — |
| DINA^{b)} | 3.8 | 3.6 | 3.9 | 4.5 | 2.8 | 4.5 | 4.7 | 5.2 |
| TXIB^{c)} | 3.8 | 3.6 | 3.9 | 7.9 | 2.8 | 4.5 | 4.7 | 10.4 |
| DINCH | 16.7 | 15.5 | 16.9 | 14.7 | — | — | — | — |
| Polymeric adipate | — | — | — | — | — | — | — | 2.3 |
| Mesamoll ®^{d)} | — | — | — | — | — | — | — | 6.9 |
| Stabilizers: | | | | | | | | |
| Epoxy costabilizer | 1.2 | 1.1 | 1.2 | 1.7 | 1.2 | 1.1 | 1.7 | 1.7 |
| Sn-heat stabilizer | — | — | — | — | 0.9 | 0.8 | 0.9 | — |
| Ba-Zn heat stabilizer | 1.5 | 1.4 | 1.5 | — | — | — | — | — |
| Ca-Zn-heat stabilizer | — | — | — | 1.7 | — | — | — | 1.7 |
| UV-stabilizer | — | — | — | 0.2 | — | — | — | 0.2 |
| Flame inhibitors: | | | | | | | | |
| Antimony trioxide | — | — | — | 2.3 | 0.9 | 1.7 | 2.3 | 2.3 |
| Barium metaborate | 1.6 | 1.5 | 1.6 | — | 0.9 | 0.8 | 1.6 | — |
| Solvents: | | | | | | | | |
| De-aromatized | | | | | | | | |
| White Spirit | 2.6 | 4.6 | 3.2 | — | 2.3 | 2.0 | 2.6 | — |
| Butyl glycol diacetate | 1.3 | 2.3 | 2.2 | 5.7 | 2.0 | 1.7 | 2.3 | 6.9 |
| Pigments: | | | | | | | | |
| Titanium dioxide | 7.4 | 11.1 | — | — | 7.2 | 11.2 | — | — |
| Carbon Black | (0.02) | — | 0.2 | — | (0.02) | — | 0.2 | — |
| Inorganic | | | | | | | | |
| yellow pigment | 0.3 | — | 0.2 | — | 0.3 | — | 3.6 | — |
| Organic | | | | | | | | |
| brown pigment | — | — | 0.9 | — | — | — | 0.9 | — |
| Aluminum pigment | — | — | — | 4.5 | — | — | — | 4.6 |

^{a)}Diisodecyl phthalate;
^{b)}Diisononyl adipate;
^{c)}1-Isopropyl-2,2-dimethyltrimethylene diisobutyrat (Texanol ®-diisobutyrat);
^{d)}plasticizer obtained from Lanxess

The coating composition can be compared with each other in the following way:

| Example | Comparative Example |
|---|---|
| 1 | V1 |
| 2 | V2 |
| 3 | V3 |
| 4 | V4 |

The coating compositions 1 to 4 and the coating compositions V1 to V4 were excellently suited for the coil coating process.

### Examples 5 to 8 and Comparative Examples V5 to V8

### The Preparation of Coated Coils from Coating Compositions Containing DINCH (Examples 5 to 8) and of Coated Coils from Coating Compositions Containing No DINCH (Comparative Examples V5 to V8) by the Coil Coating Process

The coating compositions of the Examples 1 to 4 and of the Comparative Examples V1 to V4 were used for the preparation of the coated coils of the Examples 5 to 8 and of the Comparative Examples V5 to V8 in the following way:

| Coating Composition: | Coated Coil: |
|---|---|
| Example or | Example or |
| Comparative Example | Comparative Example |
| 1 | 5 |
| 2 | 6 |
| 3 | 7 |
| 4 | 8 |
| V1 | V5 |
| V2 | V6 |
| V3 | V7 |
| V4 | V8 |

The coating compositions were applied onto coils consisting of HDG (hot dipped galvalume) steel which were provided with a polyacrylate primer coating having a thickness of 3 to 5 μm, and were hardened or gelled at a PMT of 205 to 215° C. Coated coils with a top coat having a layer thickness of 200 μm were obtained.

It became apparent that because of the use of the coating compositions containing DINCH of the Examples 1 to 4 the coil speeds could be significantly increased as compared with the coil speeds in the case of the use of the coating compositions being free of DINCH of the Comparative Examples V1 to V4. The following order of coil speeds resulted:

Coating composition V4 (containing Mesamoll™)<coating compositions V1 to V3 (containing DIDP)<coating compositions 1 to 4 (containing DINCH),

wherein the coil speeds within the order could be increased in steps of 20 m/min each. The production of the coated coils of the Examples 5 to 8 was therefore significantly more efficient than the production of the coated coils of the Comparative Examples V5 to V8.

Surprisingly, the coated coils of the Examples 5 to 8 were superior to the coated coils of the Comparative Examples V5 to V7 in terms of the cold flex. This was corroborated by low temperature T-bend tests. To this end, a test strip of the dimensions 4″×2″ was cut from a coated coil to be tested. The test strip was folded manually through 180° around a 6-7 mm mandrel to give a 2″ wide folded surface. The folded panel to be tested was attached to a thermocouple and immersed in dry ice along with the vice shields until the temperature of −60° C. was reached. The panel and the vice shields were then taken out to warm up to the required test temperature. Immediately thereafter, the folded panel was placed in the vice and pressed flat during a time period of 1 to 5 s so that a 0T bend was obtained. The resulting folded edge was examined immediately after bending with a tenfold magnification.

The results are compiled in the Table 2. In each case it is indicated as to whether strong cracking (score ++), only slight cracking (score +) or no cracking (score −) occurred.

TABLE 2
The results of the low temperature T-bend tests

| Examples and | | | | | |
|---|---|---|---|---|---|
| Comparative | Test temperature: | | | | |
| Examples | 10° C. | 5° C. | 0° C. | −5° C. | −10° C. |
| 5 bis 8 | − | − | − | + | ++ |
| V5 bis V7 | − | − | ++ | ++ | ++ |

Moreover, the coated coils of the Examples 5 to 8 were clearly superior to the coated coils of the Comparative Examples V5 to V8 in terms of the weathering stability, which was corroborated by the UV-B tests according to ASTM G53-88 (lamp: wavelength 313 nm; cycle: 8 hours light at 60° C.; 4 hours condensation at 50° C.):

Whereas the coating of the coated coil V5 was already completely delaminated after a duration of exposure of 2000 hours (score 3), the coating of the coated coil 5 was not delaminated after 2000 hours (score 0) and was only very slightly delaminated even after 3000 hours (score 1).

Whereas the coating of the coated coil V8 was already completely delaminated after 1000 hours (score 3), the coating of the coated coil 8 was only slightly delaminated after this time period (score 2).

Apart from this, all the coated coils of the Examples 5 to 8 and of the Comparative Examples V5 to V8 exhibited the same excellent application properties, as for example an excellent chemical stability.

1.-26. (canceled)

27. A coil coating process which comprises
continuously applying at least one coating composition one-sided or two-sided onto a coil to form an applied layer or layers on the coil,
subjecting the applied layer or layers to a thermal aftertreatment,
wherein the coating composition or at least one of the coating compositions contains at least one cyclohexane polycarboxylic acid ester, at least one paste PVC having a mean particle diameter of from 1 to 15 μm and at least one extender PVC having a mean particle diameter of from 25 to 35 μm.

28. The coil coating process according to claim 27, wherein the cyclohexane polycarboxylic acid is dicarboxylic acid diester.

29. The coil coating process according to the claim 28, wherein the cyclohexane dicarboxylic acid diester is 1,2-cyclohexane dicarboxylic acid diester.

30. The coil coating process according to claim 27, wherein the ester group of the cyclohexane polycarboxylic acid ester contains moieties selected from the group consisting of branched and non-branched, substituted and non-substituted alkyl moieties, cycloalkyl moieties and alkoxyalkyl moieties.

31. The coil coating process according to claim 30, wherein the moieties comprise 1 to 30 carbon atoms.

32. The coil coating process according to claim 31, wherein the moieties are alkyl moieties.

33. The coil coating process according to claim 32, wherein the alkyl moieties contain 2 to 20 carbon atoms.

34. The coil coating process according to claim 33, wherein the alkyl moieties are isononyl moieties.

35. The coil coating process according to claim 34, wherein the isononyl moieties are derived from isononanols having an iso-index, calculated from the degree of branching of the C9-alcohols contained in the isononanol and their respective fractions as measured by gaschromatography, of from 0.1 to 4.

36. The coil coating process according to claim 27, wherein the cyclohexane polycarboxylic acid ester is 1,2-cyclohexane dicarboxylic acid diisononyl ester.

37. The coil coating process according to claim 27, wherein the coating composition contains at least one additive selected from the group consisting of stabilizer, slipping agent, filler, pigment, flame inhibitor, light stabilizer, blowing agent, polymeric processing aid, impact strength modifier, optical brightener, antistatic agent, biostabilizer and polymer being different from PVC.

38. The coil coating process according to claim 36, wherein the coating composition contains at least one additive selected from the group consisting of stabilizer, slipping agent, filler, pigment, flame inhibitor, light stabilizer, blowing agent, polymeric processing aid, impact strength modifier, optical brightener, antistatic agent, biostabilizer and polymer being different from PVC.

39. The coil coating process according to claim 27, wherein the coils have been pretreated one-sided or two-sided.

40. The coil coating process according to claim 27, wherein at least one of the applied coatings is used as a topcoat after the thermal aftertreatment.

41. The coil coating process according to claim 39, wherein the topcoat is having a dry-layer thickness of from 50 to 350 μm.

42. The coil coating process according to claim 27, wherein after the thermal aftertreatment the coated coils are shaped to form three-dimensional formed parts.

43. The coil coating process according to claim 38, wherein after the thermal aftertreatment the coated coils are shaped to form three-dimensional formed parts.
